(19) United States
(12) Patent Application Publication
(10) Pub. No.: US 2014/0314424 A1
(43) Pub. Date: Oct. 23, 2014

(54) OPTICAL COMMUNICATION APPARATUS

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/192,793

(22) Filed: Feb. 27, 2014

(30) Foreign Application Priority Data
Apr. 17, 2013 (TW) 102113552

(51) Int. Cl. H04B 10/40; H04B 10/25

(52) U.S. Cl. CPC H04B 10/40; H04B 10/25
USPC 398/139

(57) ABSTRACT

An optical communication apparatus includes a PCB, a photoelectric unit, a fixing board, a coupler, and an optical fiber unit corresponding to the photoelectric unit. The photoelectric unit is electrically connected to a surface of the PCB, the fixing board is securely positioned on the surface of the PCB, and the coupler unit is connected to the fixing board. The fixing board defines a through opening portion exposing the photoelectric unit. The coupler includes a lens unit corresponding to the photoelectric unit. One of the fixing board and the coupler defines a number of positioning holes, the other of the fixing board and the coupler includes a number of positioning poles corresponding to the positioning holes. The positioning poles are inserted into the corresponding positioning holes. The lens unit is aligned with the photoelectric unit by an engagement between the positioning poles and the positioning holes.

### BACKGROUND

1. Technical Field

The present disclosure relates to an optical communication apparatus.

2. Description of Related Art

Optical communication apparatuses include a coupler and a photoelectric unit. The coupler optically couples an optical fiber unit to the photoelectrical unit. To ensure an optical transmission efficiency of the optical communication apparatus, the coupler should be accurately aligned with the photoelectric unit. However, the coupler and the photoelectric unit usually have small sizes and it is difficult to align the coupler with the photoelectric unit.

Therefore, what is needed is an optical communication apparatus addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a cross sectional view of an optical communication apparatus, according to one embodiment, wherein a cross section passes through an emitter, a first lens, and an output optical fiber of the optical communication apparatus.

FIG. 2 is another cross sectional view of the optical communication apparatus of FIG. 1, wherein a cross section passes a receiver, a second lens, and an input optical fiber of the optical communication apparatus.

FIG. 3 is an exploded view of the optical communication apparatus of FIG. 1.

### DETAILED DESCRIPTION

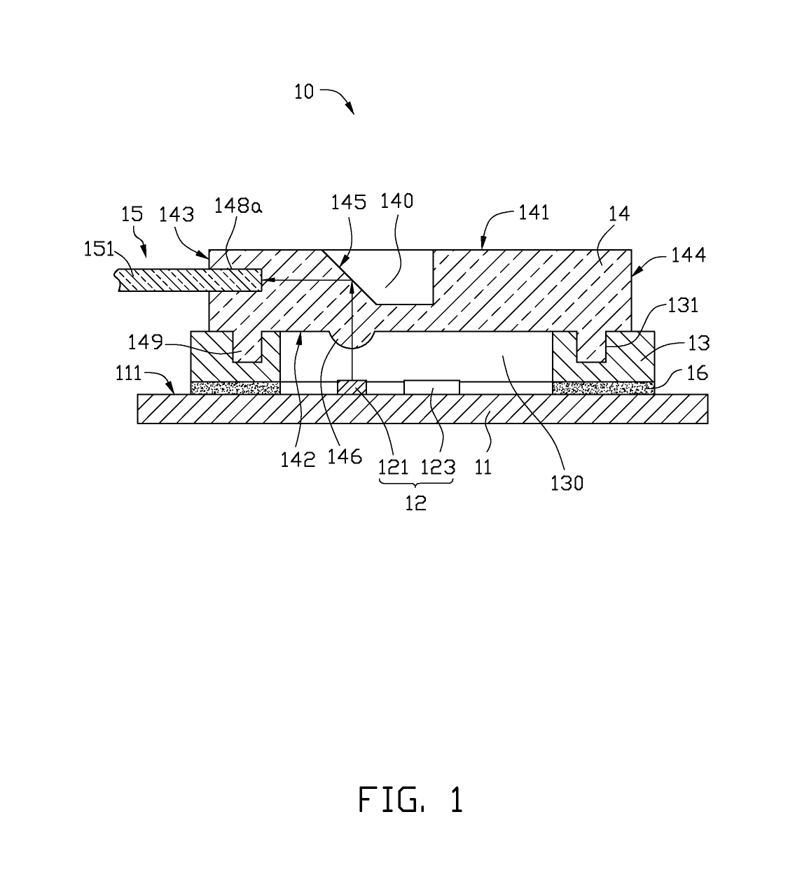

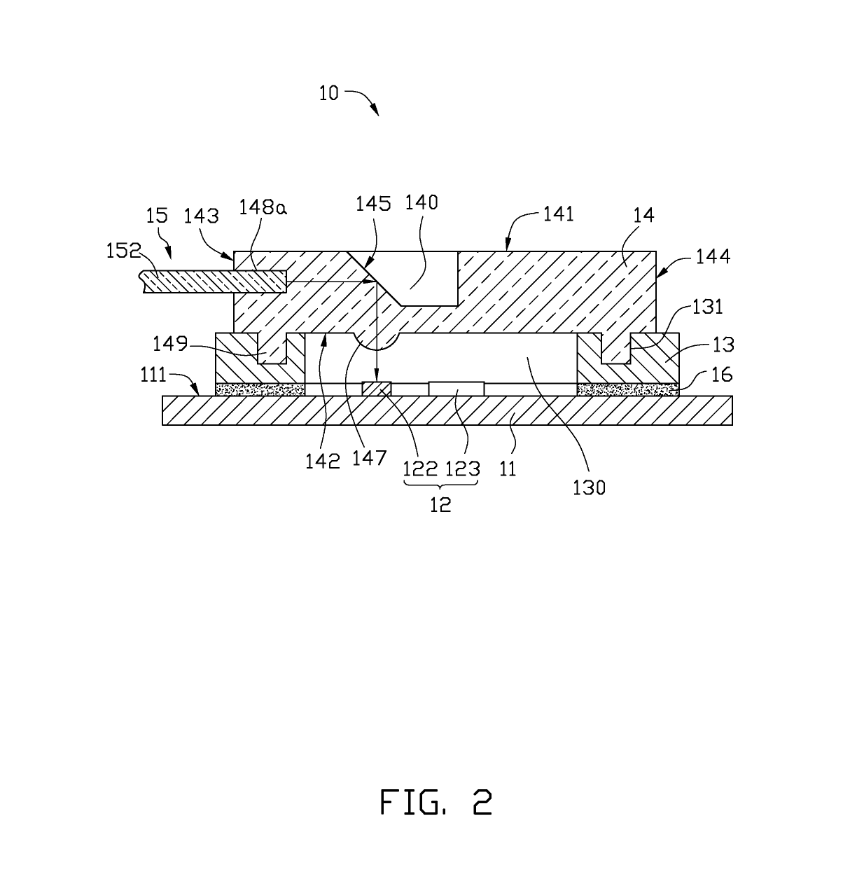

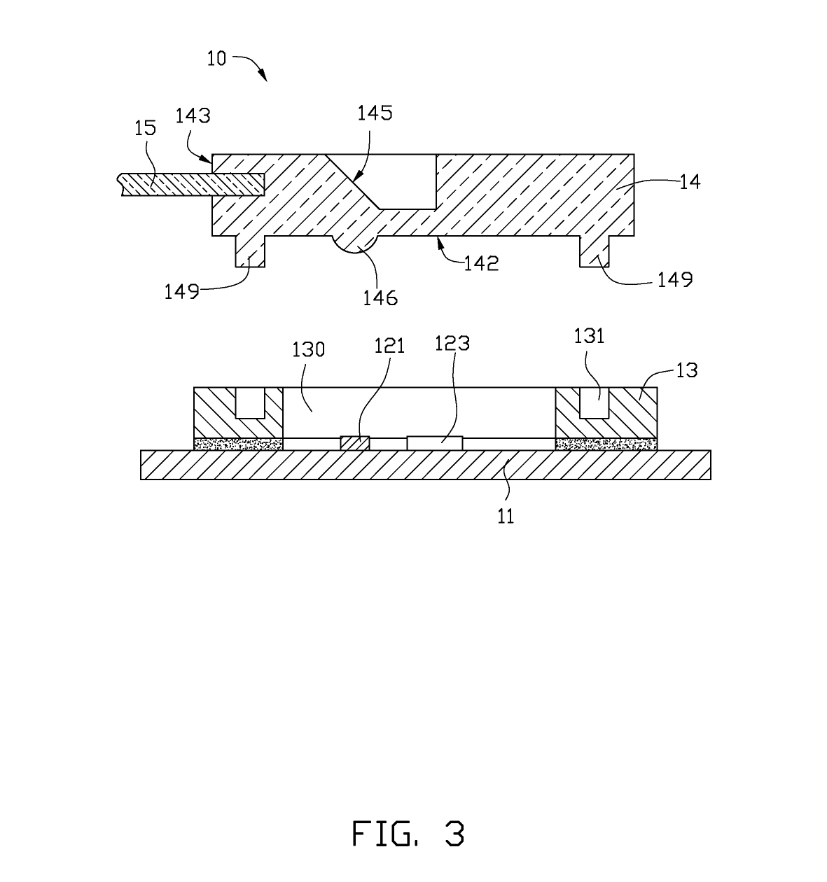

FIGS. 1-3 show one embodiment of an optical communication apparatus 10. The optical communication apparatus 10 includes a printed circuit board (PCB) 11, a photoelectric unit 12, a fixing board 13, a coupler 14, and an optical fiber unit 15. The photoelectric unit 12 and the fixing board 13 are fixedly positioned on the PCB 11, the coupler 14 is connected to the fixing board 13 covering the photoelectric unit 12, and the optical fiber unit 15 is connected to the coupler 14.

The PCB 11 can be a flexible PCB (FPCB), a rigid PCB or a rigid-flex compound PCB. The PCB 11 includes a mounting surface 111 supporting the photoelectric unit 12 and the fixing board 13.

The photoelectric unit 12 includes an emitter 121 for emitting optical signals and a receiver 122 for receiving optical signals. The emitting 121 and the receiver 122 are electrically connected to the PCB 11. In this embodiment, the emitter 121 can be a light emitting diode (LED) or a laser diode, and the receiver 122 can be a photodiode. The photoelectric unit 12 further includes a driver chip 123 electrically connected to the emitter 121 and the receiver 122. The driver chip 123 drives the emitter 121 to emit optical signals and the receiver 122 to receive optical signals.

The fixing board 13 is fixedly connected to the PCB 11 by an adhesive 16. The fixing board 13 defines an opening portion 130 in a central portion. The emitter 121 and the receiver 122 are exposed in the opening portion 130. In this embodiment, the opening portion 130 is an integral opening. Alternatively, the opening portion 130 may include a number of openings separated from each other, each of the emitter 121 and the receiver 122 is exposed in a corresponding opening. The fixing board 13 further defines a number of positioning holes 131 in a surface facing away from the PCB 11. In this embodiment, the positioning holes 131 are blind holes.

The coupler 14 is substantially rectangular. The coupler 14 includes a first surface 141, a second surface 142 opposite to the first surface 141, a third surface 143, a fourth surface 144 opposite to the third surface 143, and a reflecting surface 145. In this embodiment, the first surface 141 is substantially parallel to the second surface 142, the third surface 143 is substantially parallel to the fourth surface 144, and the first and second surfaces 141, 142 are substantially perpendicular to the third and fourth surfaces 143, 144. An angle between the second surface 142 and the reflecting surface 145 is substantial the same as the angle between the third surface 143 and the reflecting surface 145. In this embodiment, the reflecting surface 145 is formed by defining a groove 140 in the first surface 141. The reflecting surface 145 is an inner surface of the groove 140.

The coupler 14 includes a first lens 146 corresponding to the emitter 121 and a second lens 147 corresponding to the receiver 122. The first lens 146 and the second lens 147 are formed on the second surface 142 and protrude from the second surface 142 to the PCB 11. An optical axis of the first lens 146 is substantially parallel to that of the second lens 147. The optical axis of each of the first and second lenses 146, 147 is substantially perpendicular to the second surface 142. The coupler 14 includes a number of positioning poles 149 corresponding to the positioning holes 131. The positioning poles 149 protrude from the second surface 142. A shape and size of each positioning pole 149 are corresponding to those of a positioning hole 131.

The coupler 148 defines a first receiving hole 148a corresponding to the first lens 146 and a second receiving hole 148b corresponding to the second lens 147. The first receiving hole 148a and the second receiving hole 148b are defined in the third surface 143. A central axis of the first receiving hole 148a is substantially parallel to that of the second receiving hole 148b, and the central axis of each of the first and second receiving holes 148a, 148b is substantially perpendicular to the third surface 143. In this embodiment, the first and second receiving holes 148a, 148b are blind holes.

In assembly, the coupler 14 is securely connected to the fixing board 13 with the second surface 142 facing the PCB 11. The positioning poles 149 are respectively inserted into the positioning holes 131. The first lens 146 and the second lens 147 are respectively aligned with the emitter 121 and the receiver 122 along a direction substantially perpendicular to the mounting surface 111 of the PCB 11.

In this embodiment, the positioning poles 149 is formed on the coupler 14. The positioning holes 131 are defined in the fixing board 13. Alternatively, the coupler 14 may define a number of positioning holes, and the fixing board 13 may include a number of positioning poles.

The optical fiber unit 15 includes an output optical fiber 151 corresponding to the emitter 121 and an input optical fiber 152 corresponding to the receiver 122. Ends of the output optical fiber 151 and the second optical fiber 152 are securely received in the first receiving hole 148a and the second receiving hole 148b, respectively.

In use, the emitter 121 emits optical signals, the optical signals emitted by the emitter 121 pass through the second surface 142 of the coupler 14 and project on the reflecting surface 145. The reflecting surface 145 reflects the optical signals to the output optical fiber 151, and then the output optical fiber 151 transmits the optical signals to a desired device (not shown). It is understood that optical signals transmitted from the input optical fiber 152 can be received by the receiver 122 by passing along a path similar but converse to a path of the optical signals emitted by the emitter 121.

It is understood that the number of the emitters 121, the receivers 122, and the corresponding optical fibers 151, 152 can be changed according to different requirements, thus the number of the first lenses 146, the second lenses 147, the first receiving holes 148a, and the second receiving holes 148b can be accordingly changed.

The coupler 14 and the fixing board 13 are connected to each other via an engagement between the positioning holes 131 and the positioning poles 149, thus respectively aligning the first lens 146 and the second lens 147 with the emitter 121 and the receiver 122,. Therefore, it ensures an easy and precise assembly between the coupler 14 and the photoelectric unit 12.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. An optical communication apparatus, comprising:
a PCB, the PCB comprising a mounting surface;
a photoelectric unit positioned on the mounting surface and electrically connected to the PCB;
a fixing board fixedly positioned on the mounting surface of the PCB, the fixing board defining a through opening portion, the photoelectric unit being exposed in the opening portion;
a coupler connected to the fixing board, the coupler comprising a lens unit corresponding to the photoelectric unit; and
an optical fiber unit corresponding to the photoelectric unit and connected to the coupler;
wherein one of the fixing board and the coupler defines a plurality of positioning holes, the other of the fixing board and the coupler comprises a plurality of positioning poles corresponding to positioning holes, the coupler is connected to the fixing board by inserting the positioning poles into the corresponding positioning holes, and the lens unit is aligned with the photoelectric unit by an engagement between the positioning poles and the positioning holes.

2. The optical communication apparatus of claim 1, wherein the photoelectric unit comprises an emitter for emitting optical signals and a receiver for receiving optical signals, the lens portion comprises a first lens corresponding to the emitter and a second lens corresponding to the receiver, the first lens and the second lens are aligned with the emitter and the receiver along a direction perpendicular to the mounting surface.

3. The optical communication apparatus of claim 2, wherein the emitter is a laser diode, and the receiver is a photodiode.

4. The optical communication apparatus of claim 3, wherein the photoelectric unit comprises a driver chip positioned on the mounting surface and electrically connected to the emitter and the receiver, the driver chip is configured for driving the emitter to emit optical signals and the receiver to receive optical signals.

5. The optical communication apparatus of claim 1, wherein the coupler comprises a reflecting surface for reflecting optical signals between the photoelectric unit and the optical fiber unit.

6. The optical communication apparatus of claim 5, wherein the coupler comprises a first surface, a second surface opposite to the first surface, a third surface, a fourth surface opposite to the third surface, the second surface faces toward the photoelectric unit, and the optical fiber unit is connected to the third surface.

7. The optical communication apparatus of claim 6, wherein the coupler defines a groove in the first surface, the reflecting surface is an inner surface of the groove.

8. The optical communication apparatus of claim 1, wherein the PCB is selected from one of a group consisting of a flexible PCB, a rigid PCB, and a rigid-flex compound PCB.
